(19) United States
(12) Patent Application Publication
(10) Pub. No.: US 2017/0136962 A1
(43) Pub. Date: May 18, 2017

(54) IN-VEHICLE CAMERA CONTROL DEVICE

(71) Applicant: Mitsubishi Electric Corporation, Tokyo (JP)

(72) Inventors: Tsubasa MORITA, Tokyo (JP); Takehisa MIZUGUCHI, Tokyo (JP); Yoshio TODOROKI, Tokyo (JP)

(73) Assignee: Mitsubishi Electric Corporation, Tokyo (JP)

(21) Appl. No.: 15/323,013

(22) PCT Filed: Oct. 8, 2014
(86) PCT No.: PCT/JP2014/076974

§ 371 Date: Dec. 29, 2016

(51) Int. Cl. B60R 11/04; H04N 13/02; H04N 5/232; B60K 35/00

(52) U.S. Cl. CPC B60R 11/04; B60K 35/00; H04N 13/0239; H04N 5/23203; B60R 2300/101; B60R 2300/205; B60R 2300/605; B60R 2300/8053; B60R 2300/8093; B60K 2350/2013; B60K 2350/2095; B60Y 2400/90; B60Y 2400/92

(57) ABSTRACT

An in-vehicle camera control device 1 includes an evaluator 11 for evaluating an image capturing condition with reference to an image captured by an in-vehicle camera 2, an image capture suitability determiner 12 for determining whether to continue image-capturing in accordance with evaluation results generated by the evaluator 11, and a drive controller 14 for outputting a drive signal to a drive unit 22 of the in-vehicle camera 2 causing the drive unit 22 to move the in-vehicle camera 2 when the image capture suitability determiner 12 determines that the in-vehicle camera 2 is unsuitable for the image-capturing. Thus, it is possible to move the in-vehicle camera 2 to a position where a normal image can be captured when wipers etc. fail to improve the image capturing conditions.

### TECHNICAL FIELD

The present invention relates to an in-vehicle camera control device to control an in-vehicle camera.

### BACKGROUND ART

A monitoring device for monitoring outside a vehicle is known. The monitoring device controls an in-vehicle camera, which is provided in the vehicle, for capturing a scene outside the vehicle through a vehicle window. The monitoring device for monitoring outside the vehicle disclosed in Patent Literature 1 has a failsafe function. The monitoring device determines whether a captured image has an image blur by using a difference in luminance distribution characteristics between a case in which the captured image is a normal image and a case in which the captured image has the image blur. When the captured image has the image blur, the failsafe function is activated to temporarily stop monitoring.

### CITATION LIST

### Patent Literature

### Patent Literature 1: Japanese Unexamined Patent Application Publication No. 2001-028746

### SUMMARY OF INVENTION

### Technical Problem

Above-mentioned Patent Literature 1 discloses that the monitoring device for monitoring outside the vehicle can improve image capturing conditions by activating wipers or a defroster when the image blur is caused by deterioration of the image capturing conditions due to dirt on a vehicle window or windshield fog etc. After a normal image is obtained again, the monitoring device returns to a normal monitoring state from a fail state.

However, when the monitoring device fails to improve the image capturing conditions by activating the wipers or the defroster, there exists a problem that the monitoring device cannot return to the normal monitoring state from the fail state.

The present invention is made in order to solve the above-mentioned problem, and it is therefore an object of the present invention to provide an in-vehicle camera control device with which it is possible to obtain a normal image even when wipers etc. fail to improve the image capturing conditions.

### SOLUTION TO PROBLEM

An in-vehicle camera control device in accordance with the present invention controls an in-vehicle camera that is movably disposed in a vehicle for capturing a scene outside the vehicle through a vehicle window. The in-vehicle camera control device includes an evaluator for evaluating image capturing conditions with reference to an image captured by the in-vehicle camera, an image capture suitability determiner for determining whether to continue image-capturing in accordance with an evaluation result generated by the evaluator, and a drive controller for outputting a drive signal to a drive unit of the in-vehicle camera to move the in-vehicle camera when the image capture suitability determiner determines that the in-vehicle camera is unsuitable for the image-capturing.

### Advantageous Effects of Invention

According to the present invention, the in-vehicle camera is moved when the image capturing conditions is determined to be unsuitable for the image-capturing. Thus, it is possible to move the in-vehicle camera to a position where a normal image can be captured when wipers etc. fail to improve the image capturing conditions.

### BRIEF DESCRIPTION OF DRAWINGS

FIG. 1 is a block diagram for illustrating a configuration of a driving assistance system using an in-vehicle camera control device according to an Embodiment 1 of the present invention;

FIG. 2 is a diagram for illustrating an installation example of an in-vehicle camera used in the Embodiment 1 on a vehicle;

FIGS. 3A to 3F are schematic diagrams for explaining an example of a process performed by the in-vehicle camera control device according to the Embodiment 1;

FIGS. 4A to 4C are diagrams for explaining examples of luminance threshold values used in the in-vehicle camera control device according to the Embodiment 1;

FIG. 5 is a flowchart for illustrating an operation example of the in-vehicle camera control device according to the Embodiment 1;

FIG. 6 is a block diagram for illustrating an alternative configuration example of the driving assistance system using the in-vehicle camera control device according to the Embodiment 1;

FIG. 7 is a diagram for illustrating a reference position of the in-vehicle camera used in an Embodiment 2 of the present invention;

FIG. 8 is a set of diagrams for illustrating movement of the in-vehicle camera used in the Embodiment 2 when the vehicle is stopped;

FIG. 9 is a diagram for illustrating a configuration example of the in-vehicle camera used in the Embodiment 2;

FIG. 10 is a diagram for illustrating an example of an angle change of the in-vehicle camera used in the Embodiment 2;

FIG. 11 is a flowchart for illustrating an operation example of the in-vehicle camera control device according to the Embodiment 2;

FIGS. 12A and 12B are diagrams for illustrating an installation example of the in-vehicle camera used in the Embodiment 3;

FIG. 13 is a block diagram for illustrating a configuration example of the driving assistance system using the in-vehicle camera control device according to the Embodiment 4;

FIGS. 14A to 14D are diagrams for explaining a method of moving stereo cameras used in the Embodiment 4;

FIG. 15 is a flowchart for illustrating an operation example of the in-vehicle camera control device according to the Embodiment 4.

### DESCRIPTION OF EMBODIMENTS

Hereinafter, some embodiments will be explained in detail with reference to the drawings.

### Embodiment 1

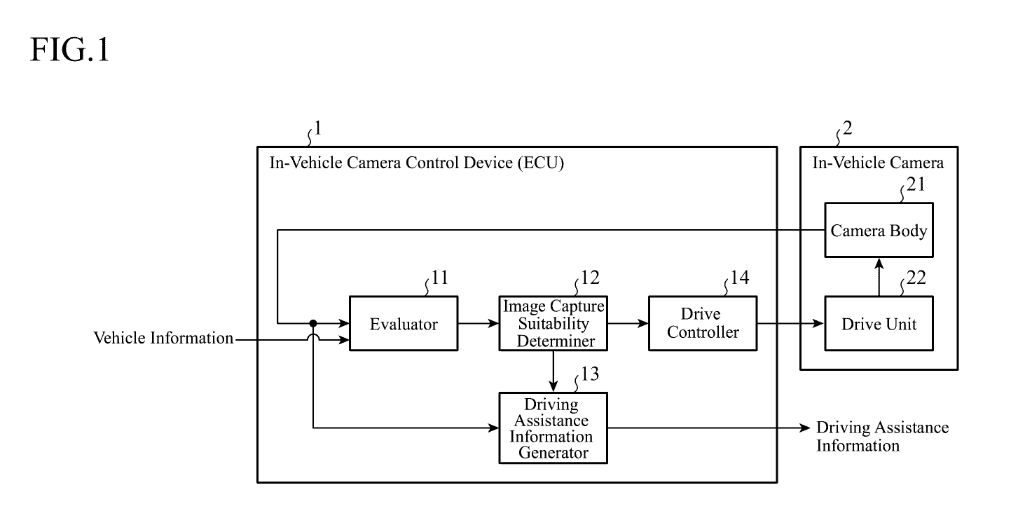

As shown in FIG. 1, an in-vehicle camera control device 1 according to an Embodiment 1 is an in-vehicle device that controls an in-vehicle camera 2. The in-vehicle camera 2 is movably disposed in a vehicle, and captures a scene outside the vehicle through a vehicle window. In the Embodiment 1, the in-vehicle camera control device 1 will be explained with reference to one example in which a driving assistance system is composed of the in-vehicle camera control device 1 and the in-vehicle camera 2.

The in-vehicle camera control device 1 is constituted by, for example, an Electronic Control Unit (ECU), and functions as each of an evaluator 11, an image capture suitability determiner 12, a driving assistance information generator 13, and a drive controller 14 by executing a program stored in an internal memory.

The in-vehicle camera 2 includes a camera body 21 and a drive unit 22. The camera body 21 has an imager such as the Charge Coupled Device (CCD). The drive unit 22 is constituted by, for example, a motor.

When dirt etc. is attached to a window glass, it obstructs a field of view of the in-vehicle camera 2 and is captured in an image. As a result, there exists a case in which the in-vehicle camera 2 fails to capture the scene outside the vehicle. Thus, the evaluator 11 evaluates “image capturing conditions”, that is, the evaluator 11 evaluates whether dirt is captured in the image. The evaluator 11 obtains a captured image from the camera body 21, and evaluates the image capturing conditions based on the luminance values of the captured image. Then, the evaluator 11 determines a movement direction of the camera body 21 based on the evaluation result. The evaluator 11 outputs, to the image capture suitability determiner 12, the evaluation result of the image capturing conditions and the camera movement information indicating the movement direction of the camera body 21.

The image capture suitability determiner 12 determines, based on the evaluation results generated by the evaluator 11, that image-capturing can be continued if dirt is not captured in the image, and that the image-capturing cannot be continued if dirt is captured in the image. The image capture suitability determiner 12 outputs, to the driving assistance information generator 13, the determination results of whether or not continuous image capturing is suitable. When the image capture suitability determiner 12 determines that the continuous image capturing is unsuitable, the image capture suitability determiner 12 also outputs, to the drive controller 14, the camera movement information, which is determined by the evaluator 11. The camera movement information is used for moving the in-vehicle camera 2 to a position where the image capturing is suitable.

When the image capture suitability determiner 12 determines that the image capturing is suitable, the driving assistance information generator 13 determines that normal driving assistance is executable in accordance with the captured image. In this case, the driving assistance information generator 13 generates information correlated with driving assistance based on the captured image obtained from the camera body 21, and outputs the information to devices including a head-up-display (HUD), a throttle control device, and a brake control device or the like. On the other hand, when the image capture suitability determiner 12 determines that the image capturing is unsuitable, the driving assistance information generator 13 determines that the normal driving assistance is inexecutable. In this case, the driving assistance information generator 13 neither generates nor outputs the driving assistance information (a fail state).

For example, when an obstacle or a person is detected based on the captured image, the driving assistance information generator 13 generates the driving assistance information to display an alert message on the HUD, or generates the driving assistance information for highlighting the obstacle or the like on the captured image. Further, for example, the driving assistance information generator 13 detects a vehicle ahead based on the captured image representing the scene ahead of the user's own-vehicle, and generate the driving assistance information to control a throttle and a brake for the purpose of an adaptive cruise (i.e. an auto cruise). Note that the captured image can be used not only for the driving assistance such as the auto cruise, but also for the automatic driving control.

The drive controller 14 generates a drive signal to drive the drive unit 22 in accordance with the camera movement information transmitted from the image capture suitability determiner 12, and outputs the drive signal to the drive unit 22. The drive signal includes information such as the movement direction of the camera body 21 and a movement distance of the camera body 21.

The drive unit 22 moves the camera body 21 based on the drive signal received from the drive controller 14.

The camera body 21 captures the scene outside the vehicle through the window, and outputs the captured image to the in-vehicle camera control device 1.

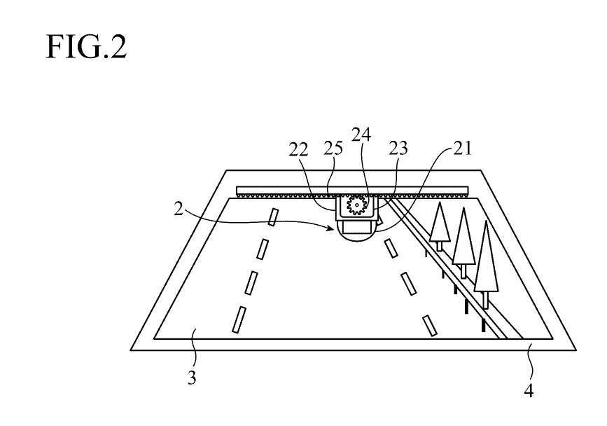

FIG. 2 is a diagram for illustrating an installation example of the in-vehicle camera 2 on a vehicle. FIG. 2 is a view from inside the vehicle toward the windshield 3.

As shown in FIG. 2, for example, a rack gear 25 is installed on the upper side of a vehicle body frame 4, and the camera body 21 is installed such that the camera body 21 is movable in the left-right direction, namely, in the horizontal direction along the rack gear 25. The drive unit 22 includes the motor 23 as a drive power source, and a pinion gear 24 meshing with the rack gear 25 and serving as a power transmitting element. When the motor 23 rotates the pinion gear 24 based on the drive signal, the camera body 21 moves in the direction opposite to the rotating direction of the pinion gear 24.

In the example shown in FIG. 2, the in-vehicle camera 2 is disposed on the windshield 3, and captures the scene ahead of the vehicle. However, this embodiment is not limited to such a configuration. The in-vehicle camera 2 may be disposed on a side window of the vehicle or a rear window of the vehicle to capture a scene at a side of the vehicle or a scene rearward of the vehicle.

Further, a plurality of the in-vehicle cameras 2 may be disposed so as to face one window. Alternatively, a plurality of the in-vehicle cameras 2 may be disposed so as to face a plurality of the windows, respectively.

In the above-mentioned example, the in-vehicle camera 2 is configured to be movable in the left-right direction, namely, horizontal direction. However, this embodiment is not limited to such a configuration. For example, the in-vehicle camera 2 may be configured to be movable in the up-down direction, namely, the vertical direction.

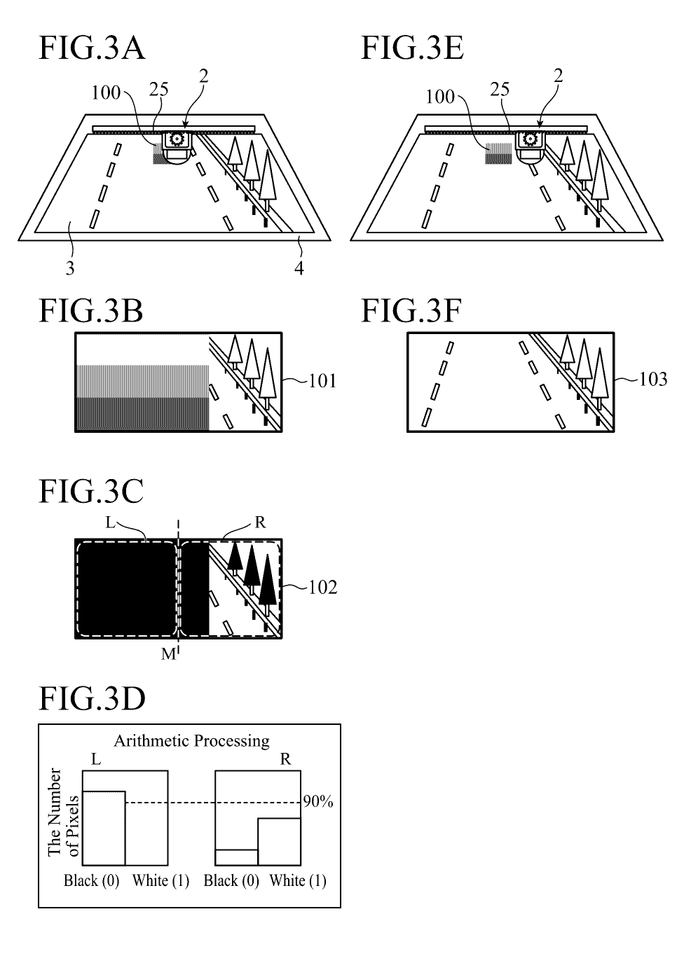

FIGS. 3A and 3B are schematic diagrams for explaining an example of a process performed by the in-vehicle camera control device 1.

In FIG. 3A, dirt 100 on the windshield 3 obstructs the capturing of a scene by the in-vehicle camera 2. In FIG. 3B, an image 101 is illustrated. The image 101 is captured by the in-vehicle camera 2 under conditions shown in FIG. 3A. The image 101 has the captured dirt 100 in the left portion, and thus the in-vehicle camera fails to capture the scene ahead of the vehicle.

The evaluation unit 11 performs a binarization process on the captured image 101, and assigns the luminance value of zero (black) or one (white) to each pixel of the captured image 101 based on a luminance threshold value.

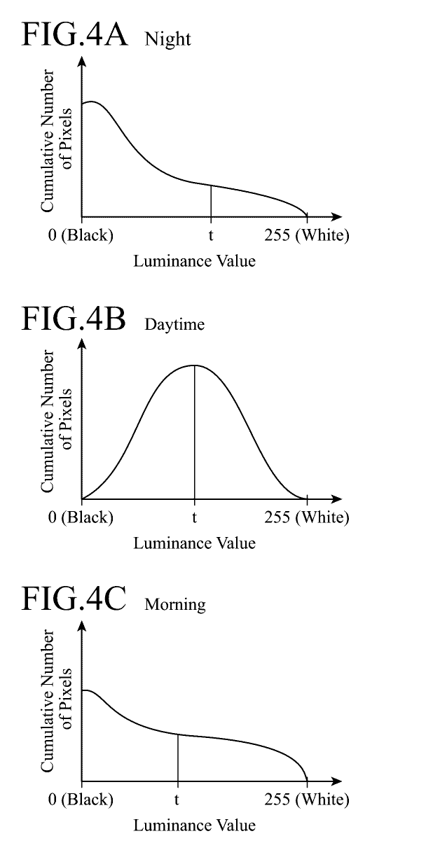

FIGS. 4A to 4C are diagrams for explaining examples of luminance threshold values. In the histograms of FIGS. 4A to 4C, the horizontal axis represents the luminance value (0 to 255), and the vertical axis represents the cumulative number of pixels. In the example shown in FIGS. 4A to 4C, the evaluator 11 selects a luminance threshold value t to be different depending on the time of the day.

In the daytime, the evaluator 11 determines the luminance threshold value t such that the ratio of the number of white pixels in the captured image after the binarization to the number of black pixels in the captured image after the binarization becomes 5:5, as shown in FIG. 4B.

In the nighttime, since it is dark around the vehicle as compared to in the daytime, the luminance values in the captured image decrease in the nighttime. Thus, the evaluator 11 determines the luminance threshold value t such that the ratio of the number of white pixels in the captured image after the binarization to the number of black pixels in the captured image after the binarization becomes 3:7, as shown in FIG. 4A.

Since it is dim in the early morning, the luminance values in the captured image become lower as compared to in the daytime but they become higher as compared to in the nighttime. Thus, the evaluator 11, in the early morning, determines the luminance threshold value t such that the ratio of the number of white pixels in the captured image after the binarization to the number of black pixels in the captured image after the binarization becomes 4 : 6, as shown in FIG. 4C.

Note that the example shown in FIG. 4 is merely one example. The method to determine the luminance threshold value t is not limited to the above-mentioned method.

For example, when the luminance value histogram has two peaks (i.e. two classes), the evaluator 11 may calculate the luminance threshold value t such that the luminance threshold value t is the valley between two peaks and such that between-class variance is maximized by way of discriminant analysis techniques.

Additionally, the evaluator 11 may smooth noise of the captured image by using a smoothing filter before the binarization.

FIG. 3C is an image 102 obtained by performing the binarization on the captured image 101 based on the luminance threshold value t. The evaluator 11 divides the binarized image 102 into two frames, that is, a left frame L and a right frame R by using a dashed line M, which is a vertical line passing the center of the image 102, as a reference line.

Next, the evaluator 11 calculates the number of pixels that belong to the left frame L and whose luminance value is zero (black), and calculates the number of pixels that belong to the left frame L and whose luminance value is one (white). Similarly, the evaluator 11 calculates the number of pixels that belong to the right frame R and whose luminance value is zero (black), and calculates the number of pixels that belong to the right frame R and whose luminance value is one (white).

The evaluator 11 outputs, to the image capture suitability determiner 12, the number of pixels that belong to the left frame L and whose luminance value is zero (black), the number of pixels that belong to the left frame L and whose luminance value is one (white), the number of pixels that belong to the right frame R and whose luminance value is zero (black), and the number of pixels that belong to the right frame R and whose luminance value is one (white) as the evaluation results of the image capturing conditions.

Moreover, the evaluator 11 compares the number of pixels that belong to the left frame L and whose luminance value is one (white) with the number of pixels that belong to the right frame R and whose luminance value is one (white). The frame including the larger number of white pixels is brighter than the other frame and is considered to have less area that is obstructed by the dirt 100. Thus, the evaluator 11 determines a direction toward the frame having the larger number of white pixels as the movement direction of the in-vehicle camera 2.

In the case shown in FIG. 3D, the ratio of the number of pixels whose luminance value is one (white) in the right frame R is larger than the ratio of the number of pixels whose luminance value is one (white) in the left frame L. Thus, the movement direction of the in-vehicle camera 2 is determined to be the direction toward right.

The image capture suitability determiner 12 determines whether to continue the image-capturing based on the evaluation results generated by the evaluator 11. For example, when the ratio of the number of pixels whose luminance value is zero (black) in the left frame L is larger than a predetermined threshold value (e.g. 90 percent) or the ratio of the number of pixels whose luminance value is zero (black) in the right frame R is larger than a predetermined threshold value, the image capture suitability determiner 12 determines that the dirt 100 obstructs the field of view of the in-vehicle camera 2, and that the image-capturing is unsuitable (i.e. driving assistance is not executable). On the contrary, when both the ratio of the black pixels in the left frame L and the ratio of the black pixels in the right frame R are equal to or less than a predetermined threshold value, the image capture suitability determiner 12 determines that the image-capturing is suitable (i.e. driving assistance is executable).

In the case shown in FIG. 3D, the ratio of the number of pixels whose luminance value is zero (black) in the right frame R is less than 90 percent. However, the ratio of the number of pixels whose luminance value is zero (black) in the left frame L is larger than 90 percent. Therefore, the image capture suitability determiner 12 determines that the image-capturing is unsuitable.

When the image capture suitability determiner 12 determines that the image-capturing is unsuitable, the drive controller 14 outputs the drive signal to drive the drive unit 22 of the in-vehicle camera 2 based on the movement direction of the in-vehicle camera determined by the evaluator 11.

In the case shown in FIG. 3D, since the image capturing is determined to be unsuitable and the movement direction of the in-vehicle camera 2 is toward right, the motor 23 in the drive unit 22 rotates in the direction opposite to the movement direction, as shown in FIG. 3E. Thus, the pinion gear 24 also rotates in accordance with the motor 23, and the in-vehicle-camera 2 moves to slide toward right. As a result, the field of view of the in-vehicle camera 2 becomes free from the dirt 100. In FIG. 3F, an image 103 is illustrated. The image 103 is captured by the in-vehicle camera 2 under conditions shown in FIG. 3E. In this case, the image 103 is free from the captured dirt 100. Therefore, when the in-vehicle camera control device 1 evaluates the image 103, the image-capturing is determined to be suitable, so that it is possible to return to a state in which the driving assistance is executable from the fail state in which the driving assistance is not executable.

In the example shown in FIGS. 3A to 3F, the in-vehicle camera 2 is movable in the left-right, horizontal direction. Therefore, the captured image after the binarization is divided into two frames, that is, the left frame and the right frame. When it is assumed that the in-vehicle camera 2 is movable in the up-down, vertical direction, the captured image after the binarization is divided into two frames, that is, an upper frame and a lower frame. In this case, the evaluator 11 may choose the movement direction of the in-vehicle camera from either an upward direction or a downward direction.

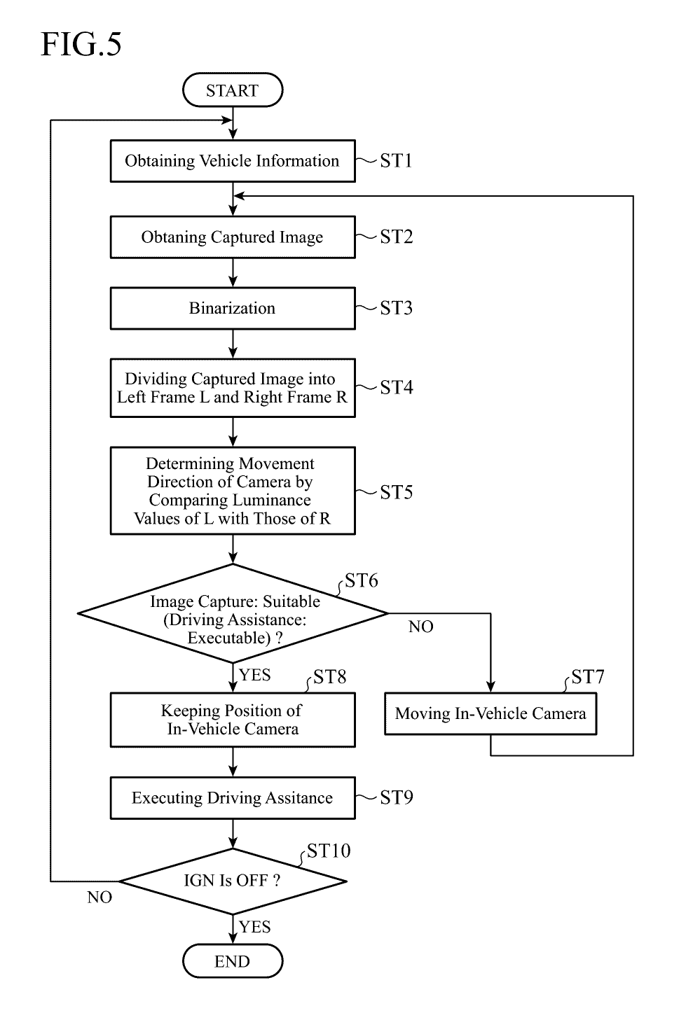

FIG. 5 is a flowchart for illustrating an operation example of the in-vehicle camera control device 1 according to the Embodiment 1.

In Step ST1, the evaluator 11 obtains vehicle information from the vehicle. The vehicle information includes ON/OFF signal of a vehicle ignition switch (IGN) and vehicle speed information.

In Step ST2, the evaluator 11 obtains the captured image from the in-vehicle camera 2.

In Step ST3, the evaluator 11 performs the binarization process on the captured image obtained from the in-vehicle camera.

In Step ST4, the evaluator 11 divides the captured image after the binarization into two frames while the vertical line passing the center of the image is used as a boundary of two frames to set the left frame L and the right frame R.

In Step ST5, the evaluator 11 compares the luminance values of the left frame L with those of the right frame R, and determines the movement direction of the in-vehicle camera 2.

In Step ST6, the image capture suitability determiner 12 determines whether to continue the image-capturing (i.e. whether the driving assistance is executable) based on the luminance values of the left frame L and the luminance values of the right frame R.

When the image capture suitability determiner 12 determines that the image-capturing is unsuitable (Step ST6 “NO”), the driving assistance information generator 13 interrupts the driving assistance. In the subsequent step, that is, in Step ST7, the drive controller 14 generates the drive signal based on the movement direction determined by the evaluator 11 in Step ST5, and outputs the drive signal to the drive unit 22. Then, the process returns to Step ST2. The drive unit 22 moves the camera body 21 in accordance with the drive signal.

Note that the moving distance of the in-vehicle camera 2 may be a predetermined distance, for example, a step of 4 cm in a single movement. By repeating from Step ST2 to Step ST7 until the image capturing becomes suitable, the in-vehicle camera 2 repeatedly moves by the predetermined distance to reach a position in which the dirt on the window is not captured.

The time interval between two processes to be repeated may be constant or may be varied in accordance with vehicle speed. For example, the drive controller 14 may use the vehicle speed information included in the vehicle information obtained by the evaluator 11, and decrease the time interval when the vehicle speed increases, and increase the time interval when the vehicle speed decreases. When the vehicle speed is high, the driving assistance is highly required. So, it is preferable that the in-vehicle camera 2 immediately moves to the position in which the field of view of the in-vehicle camera 2 is not obstructed when camera sensing becomes inexecutable. On the other hand, when the vehicle speed is low, the driving assistance is less required. Therefore, the time interval for the vehicle traveling at a low speed may be longer than the time interval for the vehicle traveling at a high speed.

When the image capture suitability determiner 12 determines that the image-capturing is suitable (Step ST6 “YES”), the in-vehicle camera 2 does not move (STEP ST8), and in subsequent Step ST9, the driving assistance information generator 13 continues the driving assistance.

In Step ST10, the evaluator 11 determines whether the vehicle ignition switch (IGN) is OFF based on the vehicle signal obtained in Step ST1.

When the evaluator 11 determines that the IGN is OFF (Step ST10 “YES”), a series of processes is terminated. On the other hand, when the evaluator 11 determines that the IGN is ON (Step ST10 “NO”), the process returns to STEP ST1.

According to such a process, when the IGN becomes OFF, the in-vehicle camera control device 1 has already moved the in-vehicle camera 2 to the position in which the image-capturing is suitable (i.e. the driving assistance is executable). Then, the process is terminated. Thus, when the IGN becomes ON again, the in-vehicle camera control device 1 can immediately start the driving assistance.

As described above, according to the Embodiment 1, the in-vehicle camera control device 1 includes the evaluator 11 to evaluate the image capturing conditions with reference to the image captured by the in-vehicle camera 2, the image capture suitability determiner 12 to determine whether to continue the image-capturing based on the evaluation results generated by the evaluator 11, and the drive controller 14 that outputs the drive signal to the drive unit 22 of the in-vehicle camera 2 to move the in-vehicle camera 2 when the image capture suitability determiner 12 determines that the in-vehicle camera 2 is unsuitable for the image-capturing. Thereby, it is possible to move the in-vehicle camera 2 to the position where a normal image can be captured when the windshield wipers etc. fail to improve the bad image capturing conditions. Thus, when the driving assistance is performed based on the camera sensing, it is possible to immediately return to the state in which the driving assistance is executable from the fail state caused by bad image capturing conditions.

According to the Embodiment 1, the image capture suitability determiner 12 determines whether to continue the image-capturing by comparing the evaluation value for the left frame L, which is the ratio of the number of pixels whose luminance value is zero (black) to the total number of pixels in the left frame L, with the predetermined threshold value, or by comparing the evaluation value for the right frame R, which is the ratio of the number of pixels whose luminance value is zero (black) to the total number of pixels in the right frame R, with the predetermined threshold value. Thereby, it is possible to accurately determine whether the dirt on the window obstructs the field of view of the in-vehicle camera 2.

Note that the in-vehicle camera control device 1 and the in-vehicle camera 2 are communicably connected via wired connection in Embodiment 1. Alternatively, the in-vehicle camera control device 1 and the in-vehicle camera 2 may be communicably connected via wireless connection.

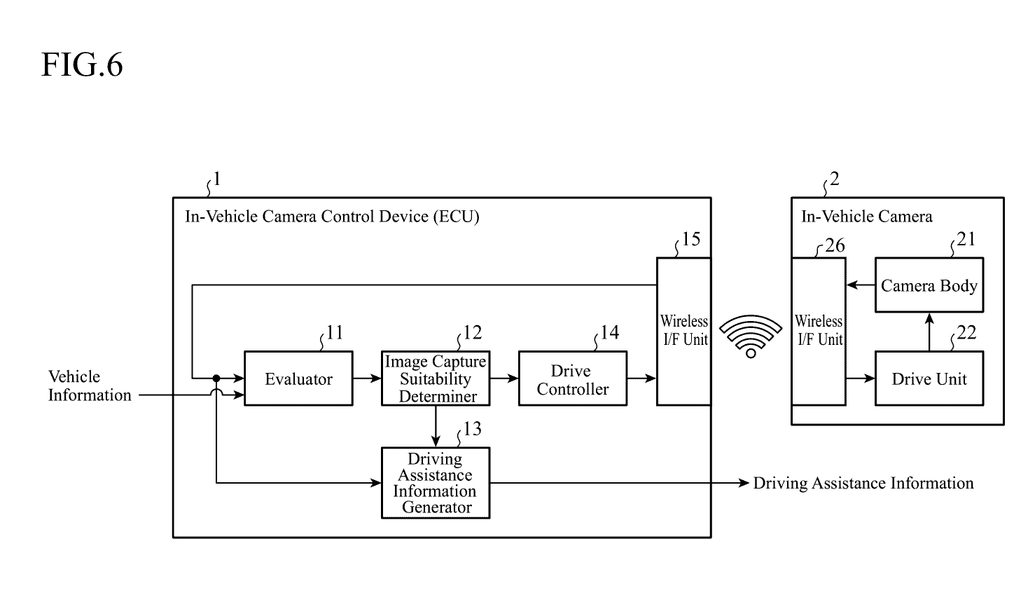

FIG. 6 is a block diagram for illustrating a configuration example in which the in-vehicle camera control device 1 and the in-vehicle camera 2 are communicably connected via wireless connection. In the configuration example shown in FIG. 6, the wireless interface (I/F) units 15, 26 which serve as interfaces for wireless communication are additionally provided to the in-vehicle camera control device 1 and the in-vehicle camera 2, respectively. The captured image and the drive signal are transmitted between the wireless I/F unit 15 and the wireless I/F unit 26.

Further, though the in-vehicle camera control device 1 controls a single in-vehicle camera 2 in Embodiment 1, it may control two or more in-vehicle cameras. In this case, the evaluator 11 evaluates the respective image capturing conditions of corresponding in-vehicle cameras 2 with reference to images captured by the corresponding in-vehicle cameras 2. The image capture suitability determiner 12 determines whether to continue each image-capturing performed by the corresponding in-vehicle camera 2 based on the evaluation result for the corresponding in-vehicle camera 2 generated by the evaluator 11. When the evaluator 11 determines that an in-vehicle camera 2 is unsuitable for the image-capturing, the drive controller 14 outputs a drive signal to the corresponding drive unit 22. Thereby, it is possible to move each of the plurality of in-vehicle cameras 2 to a position where the normal image can be captured.

### Embodiment 2

In the above-mentioned Embodiment 1, timing of moving the in-vehicle camera 2 is not restricted. In Embodiment 2, the timing of moving the in-vehicle camera 2 is restricted.

Further, in the above-mentioned Embodiment 1, the angle of the in-vehicle camera 2 is kept unchanged when the in-vehicle camera 2 moves. In Embodiment 2, the angle of the in-vehicle camera 2 is also changed when the in-vehicle camera 2 moves.

The in-vehicle camera control device 1 and the in-vehicle camera 2 according to the Embodiment 2 have the same configuration as the in-vehicle camera control device 1 shown in FIG. 1 and the in-vehicle camera 2 shown in FIG. 2, respectively, when they are represented in drawings. Therefore, FIG. 1 and FIG. 2 are also used as the drawings illustrating the in-vehicle camera control device 1 and the in-vehicle camera 2 according to the Embodiment 2.

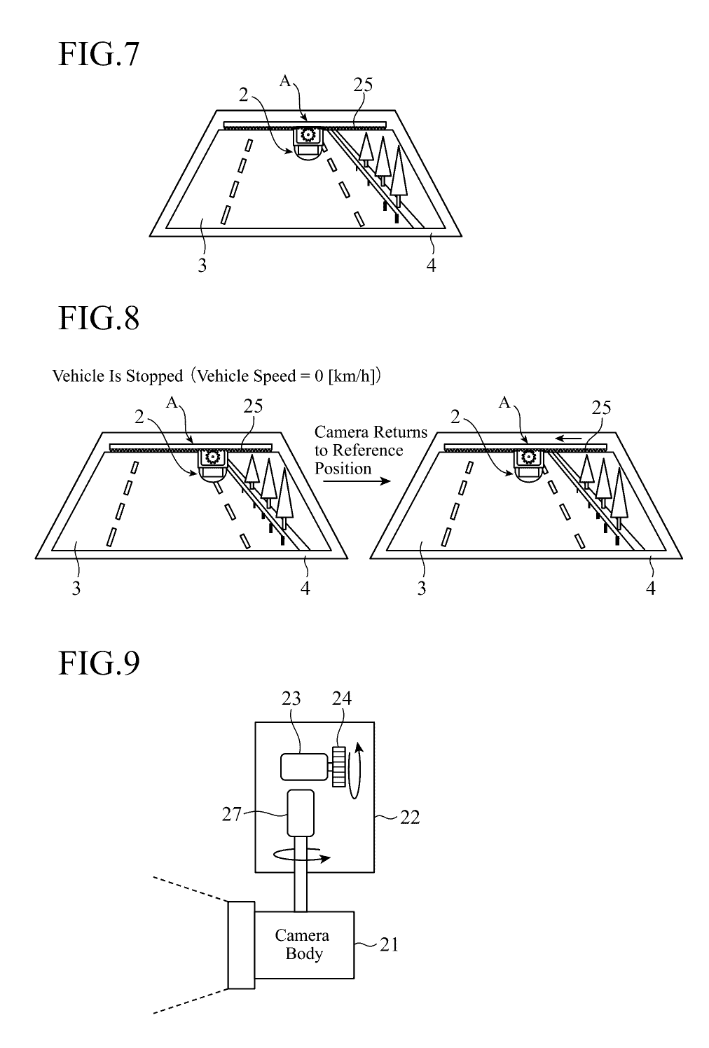

FIG. 7 is a diagram for illustrating a reference position of the in-vehicle camera 2. FIG. 8 is a diagram for illustrating movement of the in-vehicle camera 2 when the vehicle is stopped. The reference position is set so as to correspond to a position in which an image enabling normal driving assistance can be captured or correspond to a position in which the in-vehicle camera does not obstruct the view of the driver. In FIG. 7, since the position in an upper central portion of the windshield 3 is the most appropriate position, it is set as the reference position A. As shown in FIG. 8, after the vehicle stops, when the in-vehicle camera 2 is at a position other than the reference position A, the in-vehicle camera 2 returns to the reference position A

FIG. 9 is a diagram for illustrating a configuration example of the in-vehicle camera 2 used in Embodiment 2. The dashed lines show the image-capturing region (the field of view) of the camera body 21. In FIG. 9, with reference to FIG. 1 and FIG. 2, the same reference numerals refer to the same elements, and repetitive description of the same elements are omitted for sake of brevity.

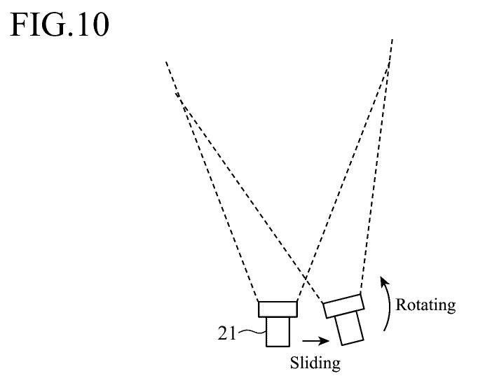

In the Embodiment 2, a motor 27 is added to change the angle of the camera body 21. The drive unit 22 drives the motor 27 in accordance with a drive signal transmitted from the drive controller 14 of the in-vehicle camera control device 1. Thereby, the in-vehicle camera 2 rotates (i.e. swings) as shown in FIG. 10. After the camera body 21 moves to slide, the motor 27 rotates the camera body 21 to change the angle of the camera body 21. Thereby, the camera body 21 is directed so that the imaging target region of the camera body 21 becomes near the imaging target region of the camera body 21 before its movement, and it is possible to reduce the difference between the imaging target region of the camera body 21 after its movement and the imaging target region of the camera body 21 before its movement.

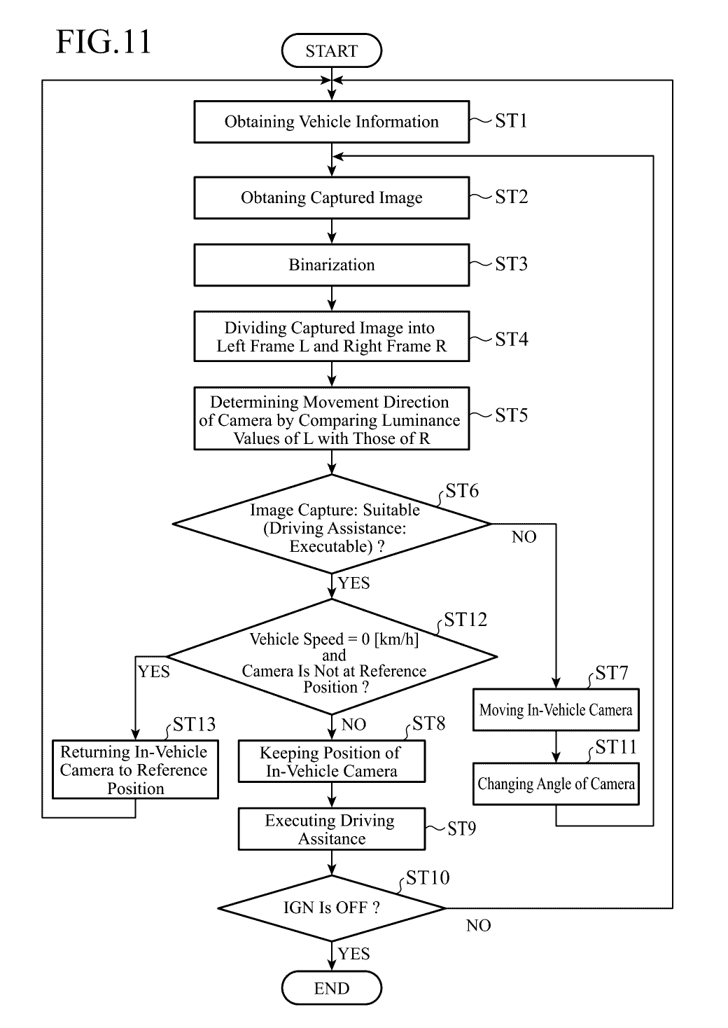

FIG. 11 is a flowchart for illustrating an operation example of the in-vehicle camera control device 1 according to the Embodiment 2. Since the process from Step ST1 to Step ST10 in FIG. 11 are the same as the process from Step ST1 to Step ST10 in FIG. 5, repetitive description for the steps is omitted for sake of brevity.

In Step ST6, the image capture suitability determiner 12 determines whether to continue the image-capturing (i.e. whether the driving assistance is executable) based on the luminance values of the left frame L and the luminance values of the right frame R.

When the image capture suitability determiner 12 determines that the image-capturing is unsuitable (Step ST6 “NO”), the drive controller 14 generates the drive signal based on the movement direction determined by the evaluator 11 and outputs the drive signal to the drive unit 22 (Step ST7). After the camera body 21 moves, the device controller 14 generates the drive signal to change the angle of the camera body 21 such that the camera body 21 after the moving turns toward the scene to be captured by the camera body 21 before the moving, and outputs the drive signal to the drive unit 22 (Step ST11). Then, the process returns to Step ST2. The drive unit 22 drives the motor 27 in accordance with the drive signal, and rotates the camera body 21.

When the image capture suitability determiner 12 determines that the image-capturing is suitable (Step ST6 “YES”), the drive controller 14 determines whether the vehicle is stopped, and determines whether the in-vehicle camera 2 is at the reference position A (Step ST12).

The drive controller 14 determines that the vehicle is stopped when the vehicle speed is 0 km/h based on the vehicle speed information which is obtained by the evaluator 11 in Step ST1. In other cases, the drive controller 14 determines that the vehicle is not stopped.

In addition, the drive controller 14 has coordinate values of the reference position A in a database, and compares the coordinate values of the reference position A with coordinate values of the in-vehicle camera 2 after the drive controller 14 moves the in-vehicle camera 2. Then, the drive controller 14 determines whether the in-vehicle camera 2 is at the reference position based on the comparison result.

Further, a switch is disposed at the reference position A. The switch is pushed when the in-vehicle camera 2 is at the reference position A, and the switch is kept projected when the in-vehicle camera 2 is away from the reference position A. Thus, it is possible to determine whether the in-vehicle camera 2 is at the reference position A also by using hardware means.

When the drive controller 14 determines that the vehicle is stopped and the in-vehicle camera 2 is at a position different from the reference position A (Step ST12 “YES”), the drive controller 14 generates the drive signal to return the in-vehicle camera 2 to the reference position A. Then, the drive controller 14 outputs the drive signal to the drive unit 22 (Step ST13), and the process returns to Step ST1. The drive unit 22 drives the motor 23 in accordance with the drive signal to move the camera body 21 to the reference position A.

When the drive controller 14 determines that the vehicle is not stopped or that the in-vehicle camera 2 is at the reference position A (Step ST12 “NO”), the process goes to the process from Step ST8 to Step ST10.

When the in-vehicle camera 2 returns to the reference position A and the dirt etc. is not captured in the image by the in-vehicle camera 2 being at the reference position A, the in-vehicle camera 2 is subsequently kept at the reference position A. Thus, it is possible to continue capturing the scenes with the in-vehicle camera 2 being at the most appropriate position.

As described above, according to the Embodiment 2, the drive controller 14 moves the in-vehicle camera 2 to a predetermined reference position when the vehicle is stopped. Thereby, it is possible to move the in-vehicle camera 2 to an appropriate position. Moreover, the timing in which the in-vehicle camera 2 returns to the reference position is restricted to the time when the vehicle is stopped. Thus, the movement of the in-vehicle camera does not obstructs driving maneuvers by the driver, even when the in-vehicle camera 2 returns to the reference position from a position far from the reference position.

Further, according to the Embodiment 2, the image capture suitability determiner 12 determines whether to continue the image-capturing by comparing the evaluation value of the image capturing conditions, which is calculated with reference to the captured image when the in-vehicle camera is at the reference position, with a predetermined threshold value. The image capture suitability determiner 12 determines that the image-capturing at the reference position is suitable when the evaluation value is less than the threshold value. Thereby, the appropriate position for the image-capturing can be kept, unless dirt etc. exists at the reference position. Thus, it is possible to provide the driving assistance system with the most appropriate image for the driving assistance.

Moreover, according to the Embodiment 2, the drive controller 14 outputs, to the drive unit 22, the drive signal to change the angle of the in-vehicle camera 2 such that the in-vehicle camera 2 after the moving turns toward the scene to be captured by the in-vehicle camera 2 before the moving. Thereby, it is possible to reduce influence of the movement of the in-vehicle camera 2.

### Embodiment 3

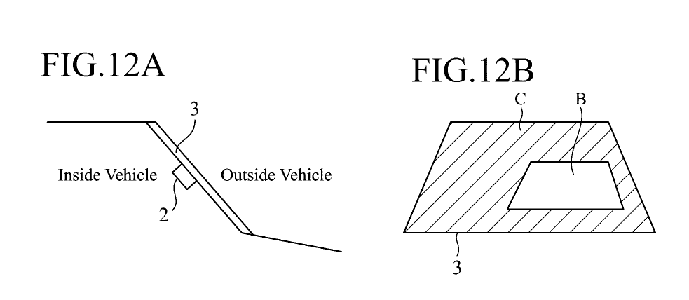

In Embodiment 3, the in-vehicle camera 2 is in contact with a vehicle window while the in-vehicle camera 2 is moving. FIG. 12A is a diagram for illustrating a state in which the in-vehicle camera 2 is disposed on the vehicle window. The drive unit 22 of the in-vehicle camera 2 has a vacuum pump and wheels which are not shown in FIG. 12A. A gap between the in-vehicle camera 2 and the windshield 3 is closed by a seal member. The drive unit 22 drives the vacuum pump to generate a suction force such that the in-vehicle camera 2 is kept in contact with the window. Under such a state, the drive unit 22 drives to rotate the wheels. Thereby, the in-vehicle camera 2 moves on the vehicle window. Thus, the in-vehicle camera 2 is able to move in a freely-selected direction while being contacted to the inner surface of the windshield 3 with suction. The in-vehicle camera 2 and the in-vehicle camera control device 1 transmits and receives the captured image and the drive signal to each other by using, for example, the wireless communication as shown in FIG. 6.

The in-vehicle camera 2 according to the Embodiment 3 can move to anywhere on the vehicle window. However, when the in-vehicle camera 2 is disposed on the windshield 3, it is preferable that the movement is restricted such that the in-vehicle 2 camera cannot move to a position where the in-vehicle camera 2 obstructs the field of view of the driver. For example, as shown in FIG. 12B, a camera movement inhibition area B, which corresponds to the field of view of the driver, may be set in the windshield 3. The remaining area is set as a camera movable area C. When the drive controller 14 generates the drive signal for the drive unit 22 in accordance with the movement direction determined by the evaluator 11, the drive signal is generated so that the movement of the in-vehicle camera 2 to the camera movement inhibition area B is avoided.

On the other hand, when the driving assistance information generator 13 executes automatic driving controls in place of the driving assistance, the driver is free from the driving maneuvers. Thus, it is allowed for the in-vehicle camera 2 to obstruct the field of view of the driver. In this case, it is not necessary to restrict the movable area of the in-vehicle camera 2. Additionally, two or more in-vehicle cameras can be disposed on the windshield 3.

### Embodiment 4

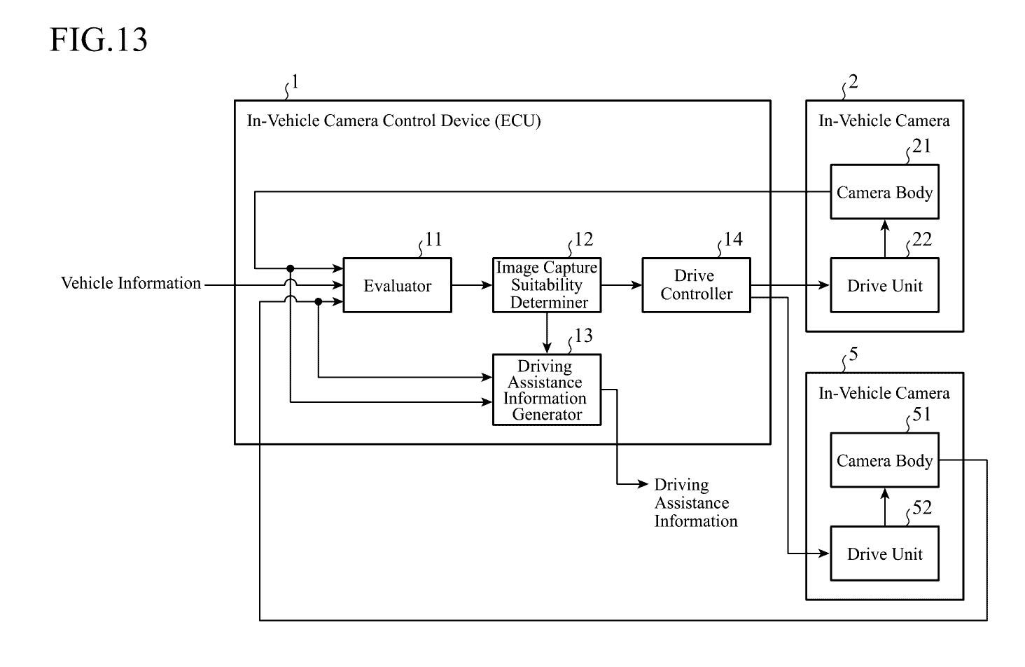

In Embodiment 4, stereo cameras are used. FIG. 13 is a block diagram for illustrating a configuration example of the in-vehicle camera control device 1 in a case where stereo cameras are used. The stereo cameras are composed of an in-vehicle camera 2 and an in-vehicle camera 5. The in-vehicle camera 5 has the same configuration as the in-vehicle camera 2, and includes a camera body 51 and a drive unit 52.

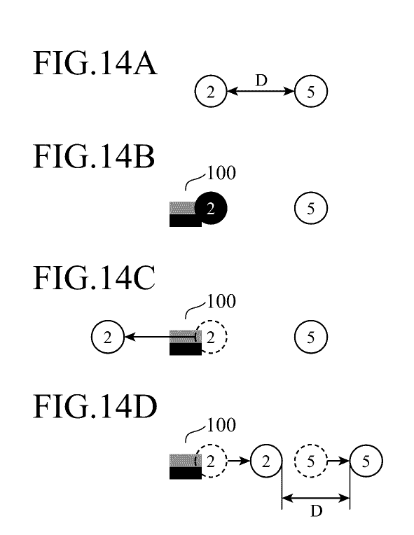

FIGS. 14A to 14D are diagrams for explaining a method of moving the in-vehicle cameras 2, 5, which constitute the stereo cameras. In FIGS. 14A to 14D, a state in which two in-vehicle cameras 2, 5 are movably disposed on the vehicle window is illustrated, while detailed structure such as the driving unit 22 is not illustrated. When the distance between two in-vehicle cameras 2, 5 is too short, two in-vehicle camera 2, 5 cannot function as the stereo cameras. So, it is required that the distance between two in-vehicle cameras is larger than a predetermined distance D.

In the state shown in FIG. 14A, the image capturing conditions of each of the in-vehicle camera 2 and the in-vehicle camera 5 are good, that is, there is no dirt 100 on the vehicle window.

In FIG. 14B, let us assume that the image capturing conditions of the in-vehicle camera 2 become worse and that the image capture suitability determiner 12 determines that the image-capturing is unsuitable. As shown in FIG. 14B, a left portion of the in-vehicle camera 2 faces the dirt 100. When the method explained in Embodiment 1 is adopted, the evaluator 11 determines that the movement direction of the in-vehicle camera 2 is the direction toward right, and the drive controller 14 moves the in-vehicle camera 2 to the right.

However, when the in-vehicle camera 2 is moved to the right, it is impossible to maintain the distance between two in-vehicle cameras 2, 5 to be equal to or larger than the distance D. Therefore, the drive controller 14 modifies the movement direction of the in-vehicle camera 2 to the direction toward left as shown in FIG. 14C to continue the camera sensing performed by the stereo cameras.

Alternatively, the drive controller 14 may also move the in-vehicle camera 5, which is determined to be suitable for the image-capturing, in addition to the in-vehicle camera 2, which is determined to be unsuitable for the image-capturing, to maintain the distance between two in-vehicle cameras 2, 5 at a distances equal to or larger than the distance D.

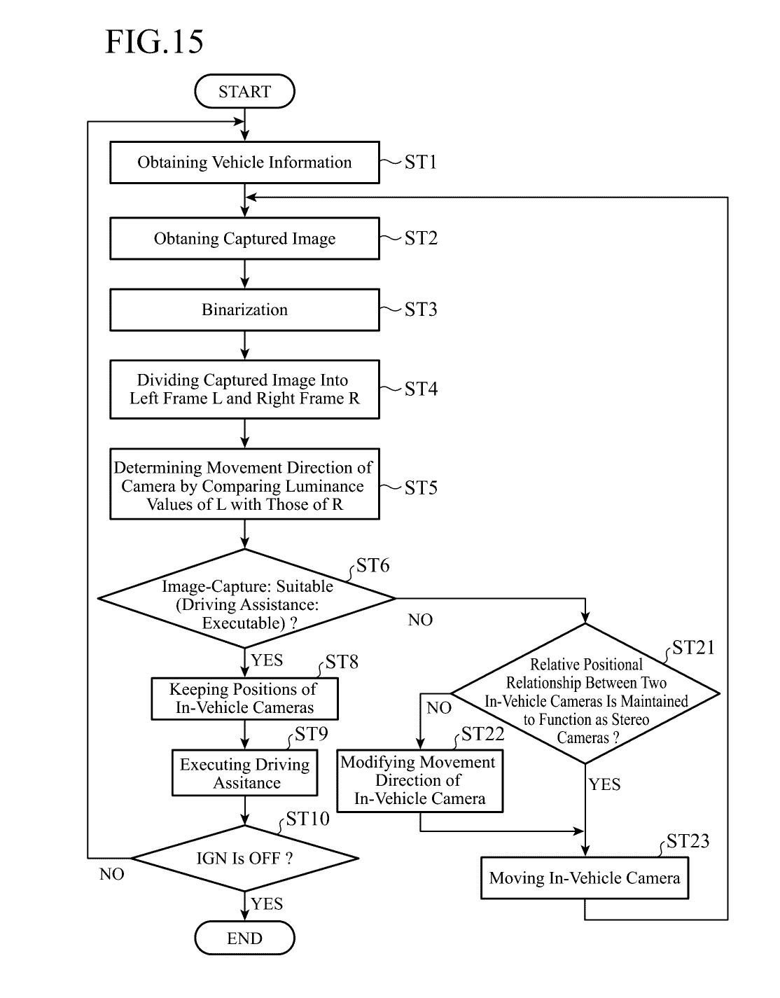

FIG. 15 is a flowchart for illustrating an operation example of the in-vehicle camera control device 1 according to the Embodiment 4. The processes corresponding to steps from Step ST1 to Step ST6 and from Step ST8 to Step ST10 indicated in FIG. 15 are the same as processes corresponding to steps from Step ST1 to Step ST6 and from Step ST8 to Step ST10 indicated in FIG. 5. However, in this Embodiment, these steps are performed for each of the image captured by the in-vehicle camera 2 and the image captured by the in-vehicle camera 5.

When the image capture suitability determiner 12 determines that at least one of the in-vehicle camera 2 and the in-vehicle camera 5 is unsuitable for the image-capturing (Step ST6 “NO”), the drive controller 14 makes the following determination. That is, the drive controller 14 determines whether a relative positional relationship between two in-vehicle cameras is to be maintained (namely, the distance between two in-vehicle cameras is to be equal to or larger than the distance D shown in FIGS. 14A and 14D) (Step ST21) after the drive controller moves at least one of the in-vehicle cameras 2, 5 which is determined to be unsuitable for the image-capturing by the evaluator 11.

When the relative positional relationship is determined to be maintained (Step ST21 “YES”), the drive controller 14 generates the drive signal based on the movement direction determined by the evaluator 11, and outputs the drive signal to at least one of the drive units 22, 52 (Step ST23). Then, the process returns to Step ST2. When at least one of the drive units 22, 52 receives the drive signal, it moves the corresponding camera body 21, 51 in accordance with the drive signal.

When the relative positional relationship is determined not to be maintained (Step ST21 “NO”), the drive controller 14 modifies the movement direction, which is determined by the evaluator 11, to a modified movement direction in which the relative positional relationship is to be maintained such that the two in-vehicle cameras keep the function of the stereo cameras (Step ST22). Then, the drive controller 14 generates the drive signal, and outputs the drive signal to at least one of the drive units 22, 52 (Step ST23). As the way of modifying the movement direction, there is the way explained above with reference to FIG. 14C or the way explained above with reference to FIG. 14D.

As mentioned above, according to the Embodiment 4, the drive controller 14 outputs the drive signal to at least one of the drive units 22, 52, which moves stereo cameras constituted by two in-vehicle cameras 22, 52. Thereby, it is possible to move at least one of the in-vehicle cameras 2, 5 to the position where the normal image can be captured when the windshield wipers etc. fail to improve the image capturing conditions in a system having the stereo cameras.

Further, according to the Embodiment 4, the drive controller 14 moves in-vehicle cameras 2, 5 under the conditions that the relative positional relationship between two in-vehicle cameras 2, 5 is maintained as shown in FIG. 14D. As a result, it is possible to move the in-vehicle cameras 2, 5 to the positions where the normal images can be captured while the function as stereo cameras is kept.

Alternatively, when the image capture suitability determiner 12 determines that either one of the two in-vehicle cameras 2, 5 is unsuitable for the image-capturing, the drive controller may move one of two in-vehicle cameras 2, 5, which is determined to be unsuitable, in a direction away from the other of two in-vehicle cameras 2, 5 as shown in FIG. 14C. Also in this case, it is also possible to move one of the in-vehicle cameras 2, 5 to the position where the normal image can be captured while the function as stereo cameras is kept.

In this disclosure, it is to be understood that a freely-selected combination of two or more of the above-mentioned embodiments can be made, various changes can be made in a freely-selected component in any one of the above-mentioned embodiments, and any component in any one of the above-mentioned embodiments can be omitted within the scope of the invention.

### INDUSTRIAL APPLICABILITY

An in-vehicle camera control device according to the present invention can move an in-vehicle camera to a position where a normal image can be captured even when dirt on a windshield or the like obstructs a field of view of the in-vehicle camera and wipers etc. fail to remove the dirt etc. Thus, the in-vehicle camera control device is suitable for a driving assistance system which performs driving assistance or automatic driving control based on camera sensing.

### REFERENCE SIGNS LIST

1: in-vehicle camera control device
2, 5: in-vehicle camera
3: windshield
4: vehicle body frame
11: evaluator
12: image capture suitability determiner
13: driving assistance information generator
14: drive controller
15: wireless I/F unit
21, 51: camera body
22, 52: drive unit
23: motor
24: pinion gear
25: rack gear
26: wireless I/F unit
27: motor.

1. An in-vehicle camera control device to control at least one in-vehicle camera movably disposed in a vehicle for capturing a scene outside the vehicle through a vehicle window, the device comprising:
an evaluator to evaluate an image capturing condition with reference to an image captured by the at least one in-vehicle camera;
an image capture suitability determiner to determine whether to continue image-capturing in accordance with an evaluation result generated by the evaluator; and
a drive controller to output a drive signal to a drive unit of the at least one in-vehicle camera to move the at least one in-vehicle camera when the image capture suitability determiner determines that the at least one in-vehicle camera is unsuitable for the image-capturing.

2. The in-vehicle camera control device according to claim 1, wherein the at least one in-vehicle camera includes a plurality of in-vehicle cameras which captures a same scene outside the vehicle, and the evaluator evaluates the image capturing condition of each of the plurality of in-vehicle cameras with reference to the image captured by each of the plurality of in-vehicle cameras,
wherein the image capture suitability determiner determines whether to continue image-capturing by each of the plurality of in-vehicle cameras based on the evaluation result generated by the evaluator, and
wherein the drive controller outputs the drive signal to move an in-vehicle camera among the plurality of in-vehicle cameras that is determined, by the image capture suitability determiner, to be unsuitable for the image-capturing.

3. The in-vehicle camera control device according to claim 1, wherein the image capture suitability determiner compares an evaluation value of the image capturing condition calculated by the evaluator with a predetermined threshold value to determine whether to continue the image-capturing.

4. The in-vehicle camera control device according to claim 1, wherein the drive controller outputs a drive signal to move the in-vehicle camera to a predetermined reference position when the vehicle stops moving.

5. The in-vehicle camera control device according to claim 4, wherein the image capture suitability determiner compares an evaluation value of the image capturing condition with a predetermined threshold value, the evaluation value being calculated with reference to the image captured by the in-vehicle camera when the in-vehicle camera is at the predetermined reference position, and
wherein the image capture suitability determiner determines that the in-vehicle camera is suitable for the image-capturing at the predetermined reference position when the evaluation value is less than the predetermined threshold value.

6. The in-vehicle camera control device according to claim 1, wherein the drive controller outputs another drive signal to the drive unit to change an angle of the in-vehicle camera such that the in-vehicle camera after moving turns toward the scene to be captured by the in-vehicle camera before the moving.

7. The in-vehicle camera control device according to claim 1, wherein the drive controller outputs the drive signal to the drive unit, wherein the drive unit moves the in-vehicle camera to maintain a state in which the in-vehicle camera is in contact with the vehicle window.

8. The in-vehicle camera control device according to claim 1, wherein the drive controller outputs the drive signal to the drive unit to move stereo cameras composing of two in-vehicle cameras included in the at least one in-vehicle camera.

9. The in-vehicle camera control device according to claim 8, wherein the drive controller outputs the drive signal to move the stereo cameras while a relative positional relationship between a camera and the other camera of the two in-vehicle cameras is maintained.

10. The in-vehicle camera control device according to claim 8, wherein when the image capture suitability determiner determines that one of the two in-vehicle cameras is unsuitable for the image-capturing, the drive controller outputs the drive signal such that the one of the two in-vehicle cameras being determined to be unsuitable moves away from the other one of the two in-vehicle cameras.
